(19) United States
(12) Patent Application Publication
(10) Pub. No.: US 2016/0258494 A1
(43) Pub. Date: Sep. 8, 2016

(54) PULLEY DAMPER WITH ONE-WAY CLUTCH

(71) Applicant: Schaeffler Technologies AG & Co. KG, Herzogenaurach (DE)

(72) Inventors: Chris Luipold, Wadsworth, OH (US); Jeff Hemphill, Copley, OH (US); Todd Sturgin, Wooster, OH (US)

(21) Appl. No.: 14/639,756

(22) Filed: Mar. 5, 2015

(51) Int. Cl. F16D 41/066; F16D 43/21; F16H 55/36; F16D 13/76

(52) U.S. Cl. CPC F16D 41/066; F16D 13/76; F16D 43/213; F16H 55/36; F16H 2055/366

(57) ABSTRACT

A one-way clutch configured for decoupling an alternator pulley from an alternator hub in a motor vehicle drive system is provided. The one-way clutch includes a ramp plate for non-rotatable connection with an inner circumferential surface of the pulley and rollers in axial engagement with the ramp plate. The rollers are movable along ramped surfaces of the ramp plate between a first position and a second position. The one-way clutch also includes an elastic assembly forcing the ramp plate and rollers into the axial engagement. The elastic assembly axially forces the rollers to transfer torque from the pulley into the hub when the rollers are in the first position. The hub is rotationally decoupled from the pulley when the rollers are in the second position.

The present disclosure relates generally to alternators of drive systems of internal combustion engines and more specifically to alternator pulley assemblies.

### BACKGROUND

Currently, a drive belt in front end accessory drives can generate a loud chirping noise when the engine is decelerated quickly such as during a shift. The quick deceleration causes the belt to slip on the alternator pulley due to the relatively large inertia of the alternator that has to be slowed down. The slipping of the belt leads to a chirping noise. An additional problem is the increased belt wear and reduced belt tensioner durability due to the lower idle speeds of internal combustion engines. U.S. Pat. No. 7,207,910, which is hereby incorporated by reference herein, purports to solve such problems.

### SUMMARY OF THE INVENTION

An object of the present disclosure is to isolate torsional vibrations from the rest of the front end accessories to improve NVH and belt wear.

A one-way clutch configured for decoupling an alternator pulley from an alternator hub in a motor vehicle drive system is provided. The one-way clutch includes a ramp plate for non-rotatable connection with an inner circumferential surface of the pulley and rollers in axial engagement with the ramp plate. The rollers are movable along ramped surfaces of the ramp plate between a first position and a second position. The one-way clutch also includes an elastic assembly forcing the ramp plate and rollers into the axial engagement. The elastic assembly axially forces the rollers to transfer torque from the pulley into the hub when the rollers are in the first position. The hub is rotationally decoupled from the pulley when the rollers are in the second position.

A pulley assembly for an alternator of a motor vehicle is also provided. The pulley assembly includes the one-way clutch, the pulley and the hub.

A method of forming a pulley assembly for an alternator of a motor vehicle is also provided. The method includes providing rollers, a ramp plate and an elastic assembly onto an alternator hub. The rollers are in axial engagement with the ramp plate at ramped surfaces of the ramp plate. The method also includes providing a pulley surrounding the rollers, the ramp plate and the elastic assembly such that the pulley is non-rotatably connected to the ramp plate. The rollers, the ramp plate and the elastic assembly selectively couple the pulley and hub together for rotation when the pulley is driven in a first rotational direction and selectively decoupling rotation of hub from the pulley when the pulley is driven in a second rotational direction opposite the first rotational direction.

### BRIEF DESCRIPTION OF THE DRAWINGS

The present invention is described below by reference to the following drawings, in which:

FIG. 1 shows a cross-sectional side view of a pulley assembly for an alternator of a motor vehicle along a center axis of the pulley assembly; and

FIG. 2 shows a cross-sectional side view of the pulley assembly radially offset from the center axis of the pulley assembly.

### DETAILED DESCRIPTION

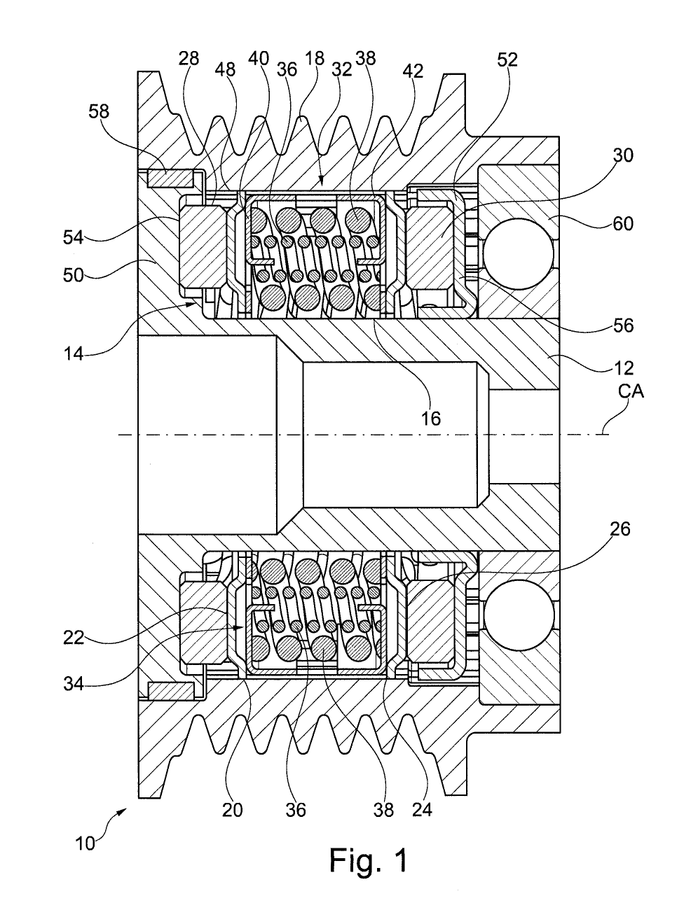

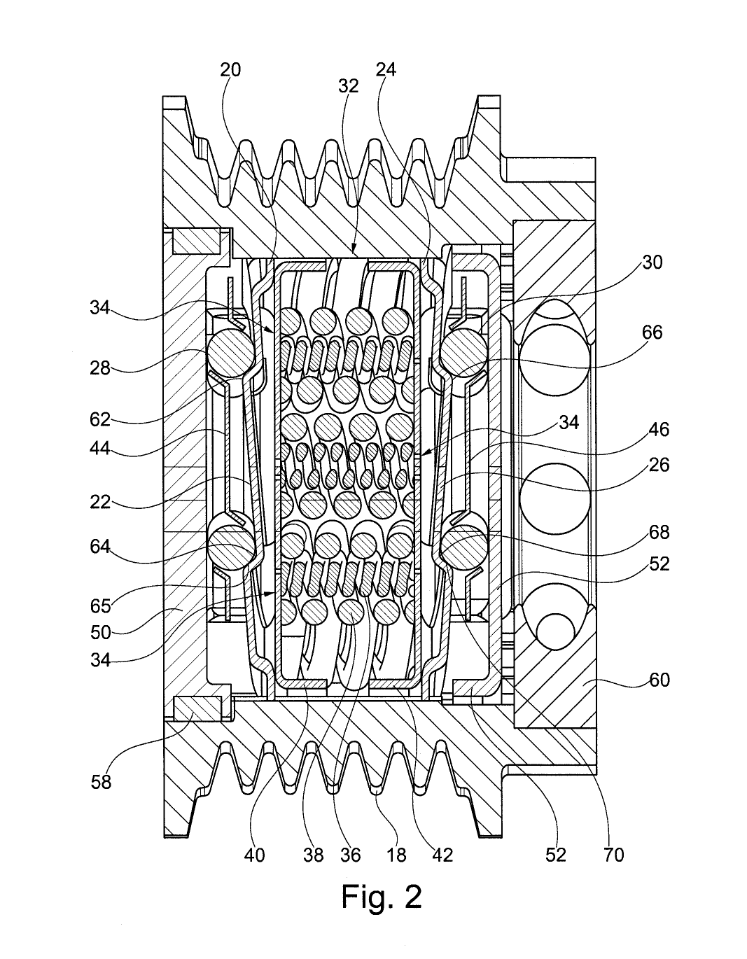

FIG. 1 shows a cross-sectional side view of a pulley assembly 10 for an alternator of a motor vehicle along a center axis CA of pulley assembly 10 and FIG. 2 shows a cross-sectional side view of pulley assembly 10 radially offset from center axis CA of pulley assembly 10. Pulley assembly 10 includes an alternator hub 12, a one-way clutch 14 on a circumferential surface 16 of alternator hub 12 and a pulley 18 circumferentially surrounding one-way clutch 14. Hub 12 is configured for receiving an alternator shaft, for example in the same manner as incorporated-by-reference U.S. Pat. No. 7,207,910, and pulley 18 is configured for supporting a drive belt of a front end accessory drive of an internal combustion engine, for example in the same manner as incorporated-by-reference U.S. Pat. No. 7,207,910.

One-way clutch 14 includes a first ramp plate 20 including a plurality of ramped surfaces 22 and a second ramp plate 24 including a plurality of ramped surfaces 26. Each first ramp plate 20 axially engages a plurality of first rollers 28 that each slide along the respective ramped surface 22 during the operation of pulley assembly 10 based on drive torque applied to pulley assembly 10 in a first direction. Likewise, each second ramp plate 24 axially engages a plurality of second rollers 30 that each slide along the respective ramped surface 26 during the operation of pulley assembly 10 based on drive torque applied to pulley assembly 10 in a first direction. In this embodiment, rollers 28, 30 are cylindrical in shaped; however, in other embodiment rollers that are spherical in shape may be used in place of rollers 28, 30.

Sandwiched axially between ramp plates 20, 24, one-way clutch 14 includes an elastic assembly 32, in the form a spring pack, that forces ramp plates 20, 24 axially away from each other and toward respective rollers 28, 30. In this embodiment, spring pack 32 includes a plurality of spring sets 34 spaced circumferentially from each other about center axis CA. Each spring set 34 may include a smaller spring 36 and a larger spring 38, which has an inner diameter that is greater that an outer diameter of smaller spring 36, surrounding smaller spring 36. In this embodiment springs 36, 38 are coil springs; however, in alternative embodiments, spring pack 32 may be formed by disc springs. Spring pack 32 also includes a first retainer plate 40 defining a first axial edge thereof axially between first ramp plate 20 and springs 36, 38 and a second retainer plate 42 defining a second axial edge thereof axially between second ramp plate 24 and springs 36, 38. First retainer plate 40 contacts a first axial end of each of springs 36, 38 and second retainer plate 42 contacts a second axial end, opposite the first axial end, of each of springs 36, 38.

As schematically shown in FIG. 2, rollers 28 are retained in a circumferentially spaced arrangement apart from each other by a first circumferentially extending cage 44 and rollers 30 are likewise retained in a circumferentially spaced arrangement apart from each other by a second circumferentially extending cage 46. Cages 44, 46 ensures that rollers 28, 30 are in the same location along respective ramped surfaces 22, 26 during the operation of pulley assembly 10.

Ramp plates 20, 24 are configured at their outer circumferences for non-rotatable connection with an inner circumferential surface 48 of pulley 18 such that ramp plates 20, 24 rotate about center axis CA with pulley 18 during operation of pulley assembly 10. In this embodiment, the outer circumferences of ramp plates 20, 24 are splined and mesh with splines formed on inner circumferential surface 48 of pulley 18. In contrast, ramp plates 20, 24 are not non-rotatably fixed on circumferential surface 16 of hub 12 at inner circumferences of plates 20, 24.

One-way clutch 14 is held axially in position on hub 12 by a radially extending flange 50 protruding radially from hub 12 and by a wedge plate 52 supported on circumferential surface 16 of hub 12. First rollers 28 axially contact an axial surface 54 of flange 50 and second rollers 30 axially contact an axial surface 56 of wedge plate 52. Flange 50 includes a bearing 58 on the outer circumferential surface thereof and a roller bearing 60 is axially adjacent to wedge plate 52. Bearings 58, 60 allow pulley 18 and hub 12 to be rotatable independent of each other when pulley 18 and hub 12 are decoupled from each other by one-way clutch 14.

Each ramped surface 22 includes a first circumferential end 62 and a second circumferential end 64, with first circumferential end 62 being further away from spring pack 32 than second circumferential end 64 such that ramped surfaces 22 are each tapered between ends 62, 64. Ramped plate 20 includes a stop 65 at each end 64 to limit the circumferential movement of rollers 28. Likewise, each ramped surface 26 includes a first circumferential end 66 and a second circumferential end 68, with first circumferential end 66 being further away from spring pack 32 than second circumferential end 68 such that ramped surfaces 26 are each tapered between ends 66, 68. Ramped plate 24 includes a stop 70 at each end 68 to limit the circumferential movement of rollers 30.

During operation of pulley assembly 10, one-way clutch 14 is configured to couple hub 12 and pulley 18 together for rotation when pulley is being driven in a first rotational direction and to decouple hub 12 and pulley 18 from each other for independent rotation when pulley 18 is being driven in a second rotational direction opposite the first rotational direction. Drive torque is applied to pulley 18 through the accessory drive belt attached to the outer circumferential surface of pulley 18. The drive torque is transmitted from pulley 18 to one-way clutch 14 by ramp plates 20, 24 via the non-rotatable connection between pulley 18 and ramp plates 20, 24. Ramp plates 20, 24 translate the drive torque into axial forces through rollers 28, 30, which are wedged between respective ramp plates 20, 24 and flange 50 and wedge plate 52, respectively. The axial forces generated by the interactions of ramp plates 20, 24 and rollers 28, 30, respectively, are resisted by spring pack 32. As the drive torque increases, the drive torque forces rollers 28, 30 travel higher on ramped surfaces 22, 26, respectively, compressing spring pack 32. In other words, as the drive torque on pulley 18 increases, rollers 28, 30 slide further along ramped surfaces 22, 26, respectively, toward circumferential ends 62, 66, respectively, compressing spring pack 32. When the rollers 28, 30 are in this first position, i.e., rollers 28 are anywhere between ends 62, 64 and rollers 30 are any wherein between ends 66, 68, the friction between rollers 28 and axial surface 54 of flange 50 and the friction between rollers 30 and the axial surface 56 of wedge plate 52 causes hub 12 to rotate with pulley 18. In the first position of rollers 28, 30, spring pack 32 provides the torsional damping required to isolate the torque spikes from the rest of the front end accessory drive.

In a second position of rollers 28, 30, i.e., when rollers 28 are at ends 64 contacting stops 65 and rollers 30 are at ends 68 contacting stops 70, due to a lack of frictional force between rollers 28 and axial surface 54 of flange 50 and a lack of frictional force between rollers 30 and the axial surface 56 of wedge plate 52, rollers 28, 30 slip along axial surfaces 54, 56, respectively, and drive torque is not transferred by one-way clutch 14 from pulley 18 to hub 12 and therefore to the alternator. Rollers 28, 30 are forced to the second position when the torque is reversed, initiating a disconnect function that decouples hub 12 from pulley 18.

In the preceding specification, the invention has been described with reference to specific exemplary embodiments and examples thereof It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A one-way clutch configured for decoupling an alternator pulley from an alternator hub in a motor vehicle drive system comprising:
a ramp plate for non-rotatable connection with an inner circumferential surface of the pulley;
rollers in axial engagement with the ramp plate, the rollers being movable along ramped surfaces of the ramp plate between a first position and a second position; and
an elastic assembly forcing the ramp plate and rollers into the axial engagement, the elastic assembly axially forcing the rollers to transfer torque from the pulley into the hub when the rollers are in the first position, the hub being rotationally decoupled from the pulley when the rollers are in the second position.

2. The one-way clutch as recited in claim 1 wherein the rollers are axially sandwiched between the ramp plate and a flange of the hub or a part fixed to the hub, the rollers rolling circumferentially along a surface of the flange of the hub or the part fixed to the hub to alternate between the first and second positions.

3. The one-way clutch as recited in claim 1 wherein the elastic assembly axially presses against an axial contact surface of the ramp plate that is opposite of the ramped surface.

4. The one-way clutch as recited in claim 3 wherein the elastic assembly is a spring pack including at least one spring and spring retainer contacting the axial contact surface of the ramp plate.

5. The one-way clutch as recited in claim 4 wherein the at least one spring includes a plurality of spring sets spaced from each other circumferentially about a center axis of the damping apparatus.

6. The one-way clutch as recited in claim 5 wherein each spring set includes a smaller spring and a larger spring surrounding the smaller spring.

7. The one-way clutch as recited in claim 1 wherein ramp plate includes one of the ramped surfaces for each of the rollers, each of the ramped surfaces being tapered away from the elastic assembly such that the rollers are further away from the elastic assembly in the first position than in the second position.

8. The one-way clutch as recited in claim 7 wherein the ramp plates includes a plurality of stops, each of the stops being connected to one of the ramped surfaces and contacting the respective roller in the second position.

9. The one-way clutch as recited in claim 1 further comprising a cage for receiving the rollers and maintaining a circumferential spacing of the rollers with respect to each other.

10. A pulley assembly for an alternator of a motor vehicle comprising:
the one-way clutch as recited in claim 1;
the pulley; and
the hub.

11. The pulley assembly as recited in claim 10 wherein the one-way clutch further includes:
a second ramp plate for non-rotatable connection with the inner circumferential surface of the pulley; and
second rollers in axial engagement with the second ramp plate, the second rollers being rotationally movable along second ramped surfaces of the second ramp plate between a first position and a second position,
the elastic assembly being axially between the first ramp plate and the second ramp plate, the elastic assembly forcing the second ramp plate and the second rollers into the axial engagement, the elastic assembly axially forcing the second rollers to transfer torque from the pulley into the hub when the second rollers are in the first position, the hub being rotationally decoupled from the pulley when the second rollers are in the second position.

12. The pulley assembly as recited in claim 11 further comprising a wedge plate fixed to the hub, the hub including a radial flange, the one-way clutch assembly being axially between the wedge plate and the radial flange such that the rollers contact an axial surface of the radial flange and the second rollers contact an axial surface of the wedge plate.

13. The pulley assembly as recited in claim 10 wherein an outer circumferential surface of the puller is configured for receiving a drive belt.

14. A method of forming a pulley assembly for an alternator of a motor vehicle comprising:
providing rollers, a ramp plate and an elastic assembly onto an alternator hub, the rollers being in axial engagement with the ramp plate at ramped surfaces of the ramp plate; and
providing a pulley surrounding the rollers, the ramp plate and the elastic assembly such that the pulley is non-rotatably connected to the ramp plate,
the rollers, the ramp plate and the elastic assembly selectively coupling the pulley and hub together for rotation when the pulley is driven in a first rotational direction and selectively decoupling rotation of hub from the pulley when the pulley is driven in a second rotational direction opposite the first rotational direction.

15. The method as recited in claim 14 wherein the elastic assembly forces the ramp plate and rollers into the axial engagement, the rollers being movable along the ramped surfaces of the ramp plate between a first position and a second position, the elastic assembly axially forcing the rollers to transfer torque from the pulley into the hub when the rollers are in the first position, the hub being rotationally decoupled from the pulley when the rollers are in the second position.

16. The method as recited in claim 15 wherein the rollers are provided on the hub such that the rollers are axially sandwiched between the ramp plate and a flange of the hub or a part fixed to the hub, the rollers rolling circumferentially along a surface of the flange of the hub or the part fixed to the hub to alternate between the first and second positions.

17. The method as recited in claim 14 further comprising providing second rollers and a second ramp plate onto the hub, the second rollers being in axial engagement with the second ramp plate at second ramped surfaces of the second ramp plate, the elastic assembly being sandwiched between the first and second ramps and forcing the first and second ramps away from each other.

18. The method as recited in claim 17 further comprising providing a wedge plate in contact with the second rollers, the roller being in contact with a flange of the hub such that the rollers, the ramp plate, the elastic assembly, the second ramp plate and the second rollers are sandwiched axially between the wedge plate and the flange.
